(19) United States
(12) Patent Application Publication
(10) Pub. No.: US 2025/0110719 A1
(43) Pub. Date: Apr. 3, 2025

(54) SYSTEM AND METHOD FOR DYNAMIC INTERPRETATION OF AUTOMATIC IDENTIFICATION AND DATA COLLECTION MEANS

(71) Applicant: Mark Herschberg, New York, NY (US)

(72) Inventor: Mark Herschberg, New York, NY (US)

(21) Appl. No.: 18/900,702

(22) Filed: Sep. 28, 2024

Related U.S. Application Data
(60) Provisional application No. 63/587,066, filed on Sep. 29, 2023.

(51) Int. Cl. G06F 8/61

(52) U.S. Cl. CPC G06F 8/61

(57) ABSTRACT

Method, system, and computer-readable medium for dynamic interpretation of automatic identification and data collection (AIDC) unit. The method includes extracting data from an AIDC unit or user input through a computing device, dynamically interpreting the extracted data based on a context, and executing an action based on the dynamic interpretation. The context may indicate whether a software package is installed on the computing device or the device's specifications. For the extracted data being interpreted for an initial occasion (such as when software package is not installed), the method includes retrieving and installing a software package associated with the extracted data. For subsequent occasions (when the software package is installed), the method includes retrieving and loading application data into the software package from the application server.

### TECHNICAL FIELD

The present disclosure relates to data extraction and retrieval. In particular, the present disclosure relates to a system and a method for dynamic interpretation of automatic identification and data collection (AIDC) means.

### BACKGROUND

Automatic identification and data collection (AIDC) means, such as Quick Response (QR) codes, barcodes, and the like, are often used to encode data therein. The encoded data may be installed, processed, and/or stored in a computing device/user equipment/mobile device, smartphones, as software components/applications. These applications or “apps” are primarily accessible through “application/app stores” or “platforms” where the applications may be listed. For example, the data may include Uniform Resource Locators (URLs) that redirect the device scanning the QR code to the appropriate platform from which the required application may be downloaded. In another example, the data may be associated with an ‘in-app’ feature, such as a map of a new location, which may be loaded on an appropriate application.

However, different applications have different protocols for listing applications. For example, an application named “Brain Bump” may be listed correctly with a space between the words on the Google Play store, but on Apple's App Store, it might not always be found this way (either because the name may have been reserved by some other entity or because App store discourages the use of spaces). This inconsistency can cause confusion when communicating how to access the application. Users might be instructed to search for “Brain Bump” on the app store, but due to the different listing protocols, iPhone® users might not find the app if they include the space. This discrepancy complicates the message and reduces the likelihood of successful app downloads, especially in scenarios where clear and concise instructions are crucial, such as during a podcast or in an online advertisement.

Furthermore, requiring users to perform multiple steps to load data on the application is cumbersome and prone to errors. For instance, in a map application, users might first need to scan a QR code to download the app from an app store, and then perform additional steps to find and download specific map data within the app. This multi-step process not only increases the likelihood of user errors, but also reduces user engagement, leading to a lower conversion rate. Alternatively, multiple QR codes (or generally AIDC means) may be provided to handle different tasks (such as one QR code each for downloading the application and loading the data therein), but such approaches add complexity. For example, a user might be given a first QR code to download the app and a second QR code to access specific content within the app. While this method can be effective in certain scenarios, it increases the likelihood of user errors. Users might scan the wrong QR code first, leading to confusion and frustration. For example, in a marketing campaign, providing two separate QR codes on a flyer (the first for app download and the second for content access) can overwhelm users, especially if the flyer has limited space. Further, the QR codes may also have dependencies associated therewith. For example, the user may be expected to scan the first QR code to download the app, and then scan the second QR code to download the content. However, in such cases, the users are required to understand the order in which the QR codes are to be scanned, and if there is a failure during the downloading of the application, the second QR code cannot be scanned to download the content. This complexity can reduce user engagement and lower the overall conversion rate. Additionally, it becomes impractical to include multiple QR codes, URLs, or other addresses to be displayed in a limited space, such as in websites, handouts, banners, advertisements, etc. Current solutions are not adapted or adaptable to use single AIDC means to perform multiple functions, based on the context.

Another problem with existing solutions is the discarding of pre-install and post-install data. When a user is directed to an app download page in an app store, the server associated with the application is not provided with any indication or means for identifying the source/origin of the request (i.e., which AIDC means was used by the user to arrive at the app download page). Such information may be important for marketing, customization, analytics, etc. For example, marketers may want to trace the origin of the user to optimize their strategies and provide feedback on the effectiveness of different marketing channels. However, existing solutions do not capture such data automatically.

Therefore, there is a need for a more efficient solution that simplifies the process of downloading apps and accessing specific content.

### SUMMARY

In an aspect, embodiments of the present disclosure are directed to a method for dynamic interpretation of automatic identification and data collection (AIDC) means. The method includes extracting, by a processor, data from an AIDC means or an input provided by a user through a computing device, dynamically interpreting the extracted data based on a context, and executing an action based on the dynamic interpretation of the extracted data.

In some embodiments, the data extracted from the AIDC means or input provided by the user includes at least one of, a Uniform Resource Locator (URL) associated with an application server of a software package, application data associated with the software package, or installation packages associated with the software package.

In some embodiments, for dynamically interpreting the extracted data, the method may include retrieving, by the processor, a software package associated with the extracted data from an application server, for the extracted data being interpreted for an initial occasion. Further, the method may include retrieving, by the processor, application data associated with the installed software package, from the application server, for the extracted data being interpreted for a subsequent occasion.

In some embodiments, for executing an action based on dynamic interpretation of the extracted data, the method may include either installing, by the processor, the software package retrieved from the application server, or loading, by the processor, the application data from the application server into the software package.

In some embodiments, the context may include an indication of at least one of, whether the software package has been installed in the computing device, a number of occasions the AIDC means has been interpreted, or specifications of the computing device.

In some embodiments, the AIDC means may be any one or a combination of quick response (QR) codes, barcodes, magnetic tapes, radio-frequency identifiers (RFIDs), or encoded media.

In some embodiments, the AIDC means or a URL encoded within the AIDC means may include an indication of origin.

Another aspect of the present disclosure is directed to a system for dynamic interpretation of AIDC means. The system includes a processor, and a memory operatively coupled to the processor, where the memory includes one or more processor-executable instructions, which, when executed, cause the processor to, extract data from an AIDC means or an input provided by a user through a computing device, dynamically interpret the extracted data based on a context, and execute an action based on the dynamic interpretation of the extracted data.

Yet another aspect of the present disclosure is directed to a non-transitory computer-readable medium including one or more instructions to extract data from an AIDC means or an input provided by a user through a computing device, dynamically interpret the extracted data based on a context, and execute an action based on the dynamic interpretation of the extracted data.

Other aspects of the disclosure will be apparent from the following description and the appended claims.

### BRIEF DESCRIPTION OF THE DRAWINGS

FIG. 1 illustrates an example network architecture implementing a system for dynamic interpretation of automatic identification and data collection (AIDC) means, according to embodiments of the present disclosure.

FIG. 2 illustrates an example block diagram of the system, according to embodiments of the present disclosure.

FIGS. 3A and 3B illustrate a flow diagram of the system scanning the AIDC means and dynamically interpreting encoded data in the AIDC means, according to embodiments of the present disclosure.

FIG. 4 illustrates a flowchart of an example method for dynamic interpretation of AIDC means, according to embodiments of the present disclosure.

FIG. 5 illustrates an example computer system in which or with which the embodiments of the system may be implemented, according to embodiments of the present disclosure.

### DETAILED DESCRIPTION

The particulars shown herein are by way of example and for purposes of illustrative discussion of the various embodiments only and are presented in the cause of providing what is believed to be the most useful and readily understood description of the principles and conceptual aspects of the methods and compositions described herein. In this regard, no attempt is made to show more detail than is necessary for a fundamental understanding, the description making apparent to those skilled in the art how the several forms may be embodied in practice.

The present disclosure will now be described by reference to more detailed embodiments. This present disclosure, however, is embodied in different forms and should not be construed as limited to the embodiments set forth herein. Rather, these embodiments are provided so that this disclosure will be thorough and complete, and will fully convey the scope to those skilled in the art.

Unless otherwise defined, all technical and scientific terms used herein have the same meaning as commonly understood by those skilled in the art to which the present disclosure belongs. The terminology used in the description herein is for describing particular embodiments only and is not intended to be limiting. As used in the description and the appended claims, the singular forms ‘a,’ ‘an,’ and ‘the’ are intended to include the plural forms as well, unless the context clearly indicates otherwise.

Unless indicated to the contrary, the numerical parameters set forth in the following specification and attached claims are approximations that may vary depending upon the desired properties sought to be obtained and thus may be modified by the term about. At the very least, and not as an attempt to limit the application of the doctrine of equivalents to the scope of the claims, each numerical parameter should be construed in light of the number of significant digits and ordinary rounding approaches.

The present disclosure solves the need for a system and a method for dynamic interpretation of automatic identification and data collection (AIDC) means, based on the context. The method includes extracting data from an AIDC means or user input through a computing device, dynamically interpreting the extracted data based on a context, and executing an action based on the dynamic interpretation. The context may indicate whether a software package is installed on the computing device, a number of occasions the AIDC means has been interpreted, and/or the device's specifications. For the extracted data being interpreted for an initial occasion (such as when a software package is not installed), the method includes retrieving and installing a software package associated with the extracted data. For subsequent occasions (when the software package is installed), the method includes retrieving and loading application data into the software package from the application server. Hence, the present disclosure allows for dynamic interpretation of the same AIDC means, based on the context.

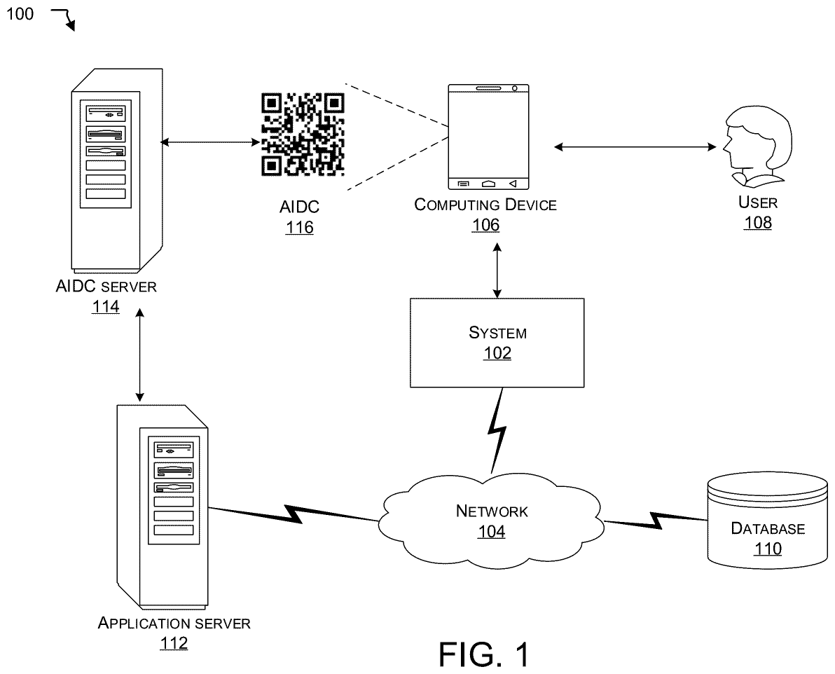

Various embodiments of the present disclosure are described in detail in reference to FIGS. 1 to 5.

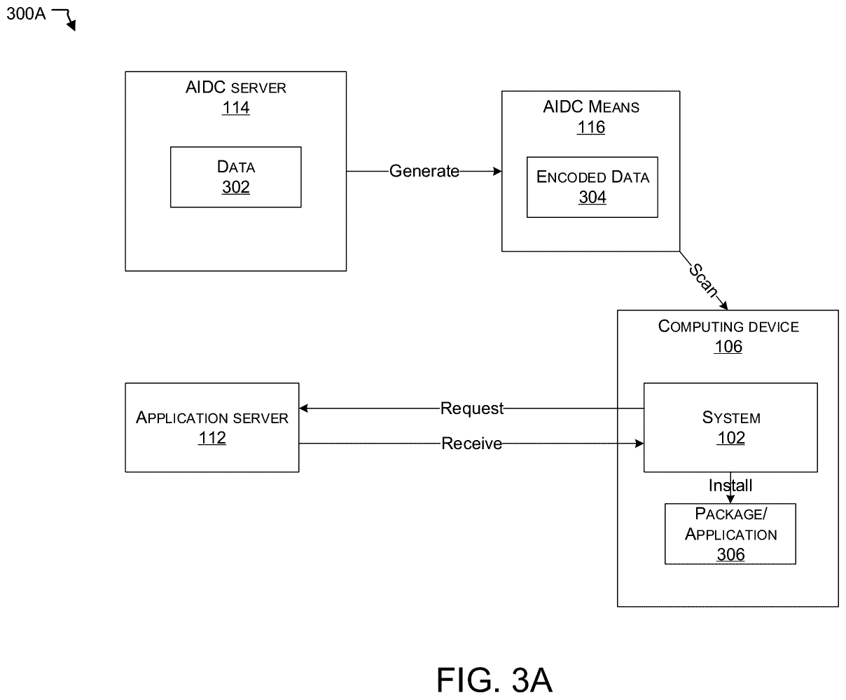

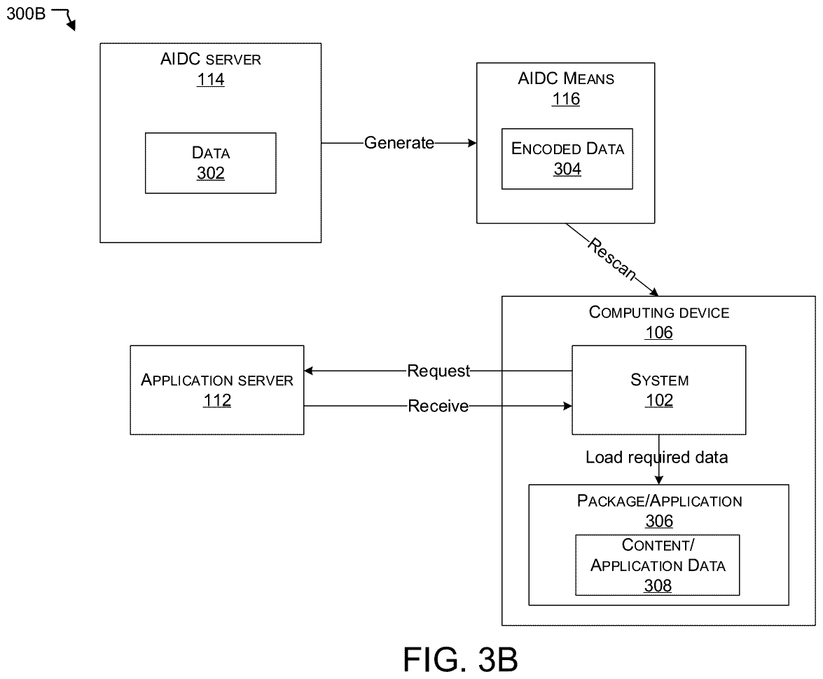

Referring to FIG. 1, in a network architecture 100, users (such as user 108) may use a corresponding user device/computing devices 106 to install and use software packages to view or obtain access to content/application data, or avail some functionality therethrough. In some embodiments, the computing device 106 may be configured to read and extract the data from an AIDC means (such as AIDC means 116) generated by an AIDC server 114. The extracted data may correspond to packages, programs, and/or routines associated with software packages (such as a map application, for example), or content/application data (such as content/application data 308 of FIG. 3B) that may be utilized by the software packages to provide additional functionality (such as map data of the location/city/building that the user 108 is in.) Either the content/application data 308 may be encoded within the AIDC means 116, or resource locators/identifiers locating the content/application data 308 (such as on the Internet) may be encoded within the AIDC means 116. In some embodiments, a system 102 (either within the computing device 106 or connected to the computing device 106) may be configured to extract the data encoded within AIDC means 116. The system 102 may also be configured to communicate with a database 110 and/or an application server 112, based on the data extracted and a context in which the data is extracted (such as specifications of the computing device 106, whether software package/applications associated with the extracted data are pre-installed in the computing device 106, and the like). The system 102 may be configured to communicate with the application server 112 and/or database 110 through a communication network 104.

In some embodiments, the computing device 106 may be operated by the user 108. The computing device 106 may be any one or combination of including, but not limited to, smartphones, mobile phones, desktop computers, laptops, tablets, virtual computers, servers, Internet-of-Things (IoT), and the like. The computing device 106 may include various input devices such as cameras, microphones, sensors, magnetic tape readers, radio frequency transceivers, touchscreen, keyboard, and or the like, but not limited thereto. The computing device 106 may be configured to communicate with other entities, such as through the network 104, using a communication means. Such communication may involve data exchange with servers, databases, other computing devices, and various networked resources, which may facilitate the functioning of software packages.

In some embodiments, the computing device 106 may support one or more software packages, applications, or apps, therein. The software packages (such as software packages/applications 306 of FIGS. 3A and 3B) may be computer programs designed to perform specific tasks or provide specific functionalities. In some embodiments, the software applications/packages 306 may be categorized into mobile apps (designed for smartphones and tablets), desktop apps (designed for personal computers and laptops), web apps (accessed through web browsers), embedded software, firmware, middleware, driver software, console applications, server-side software, wearable device software, IoT (platform) software, and the like, but not limited thereto. Examples of software packages 306 include map applications, social media apps, electronic book readers, podcast distribution apps, video-sharing apps, productivity tools, games, and the like. In some embodiments, the computing device 106 may include the system 102. In other embodiments, the computing device 106 may communicate with the system 102 if the system 102 is implemented in a separate electronic device. In such embodiments, the system 102 may be hosted on a server or another computing device, and may be configured to interact with the computing device 106 over the network 104 to perform various functions such as data extraction, processing, and the like.

In some embodiments, the computing device 106 may be configured to extract data from the AIDC means 116. The AIDC means 116 may be any one or a combination of quick response (QR) codes, barcodes, magnetic tapes, radio-frequency identifiers (RFIDs), encoded media (such as encoded audio, videos, or images), and the like, but not limited thereto. In some embodiments, the AIDC means 116 may be generated by the AIDC server 114, where the AIDC means 116 may be encoded with data associated with the software package 306. For example, the AIDC means 116 may be encoded with uniform resource locators (URLs) or uniform resource identifiers (URIs), that direct the computing device 106 to transmit requests (such as in the form of application programming interfaces (APIs)) to other applications, websites, or servers which have installation packages associated with the software package 306. In such examples, the computing device 106 may be configured to retrieve the installation packages and install the software package 306 from the URL/URI. In other examples, the installation packages may be encoded within the AIDC means 116. In further examples, the data may correspond to specific content/application data 308/information or a feature which the software package 306 may use or implement, such as multimedia files (like images, videos, audio, text documents, e-books, three-dimensional models, etc.), feature-specific packages, software programs, databases, unique identifiers, contact information, product details, map data associated with a building or a museum that the user 108 is visiting, and the like. In such examples, the content/application data 308 may be extracted, processed, and used by the software package 306, such as for displaying the map data to the user 108 on the computing device 106.

In some embodiments, the software package/application 306 may be in any one or a combination of a plurality of states. The AIDC server 114 may be configured to encode the data differently for each of the possible states of the software package/application 306. The states may correspond to additional data to be added (downloaded or otherwise) to the software package 306 (or computing device 106), additional code to be added (downloaded or otherwise) to the software package 306 (or computing device 106), configurations and/or settings of the software package 306 (or computing device 106), other conditions or states of the software package 306 (or computing device 106), and/or connections to or interactions with third-party software and entities (including, but not limited to, other IoT devices, smartphones, laptops, desktops, and servers).

In some embodiments, the AIDC server 114 may be configured to dynamically generate QR codes (or other identifiers as previously mentioned) based on the various states in which the software package/application 306 can exist. It is important to note that, in any of the aforementioned scenarios, there may be an additional set of QR codes corresponding to each application store. For example, in the scenario where additional data, denoted as X, is to be incorporated into an application (or software package 306), there may be a specific QR code for adding X to the iPhone® version of the application, and a separate, distinct QR code for adding X to the Android® version of the application.

The content/application data 308 and/or the different states of the software package 306 may be obtained by the AIDC server 114 from the applications server 112. The application server 112 may be a server configured to store data required for the operation of the software package 306, including installation packages, content/application data 308, possible states of the software package 306, operating data, location-specific data, user profiles, keys, tokens, cookies, and the like. The application server 112 may also be configured to support the functioning/operation of the software package 306. For example, when the software package 306 corresponds to an instant messaging application or an online gaming application requiring interaction between multiple ones of the users 108, the application server 112 may be configured to facilitate such communication. Such data/information may be either retrieved directly or through the network 104. The AIDC server 114 may include processing elements that take the data as input, and generate the AIDC means 116 as output.

In some embodiments, each of the AIDC server 114 and the application server 112 may be implemented in a standalone computing device, such as a server. The AIDC server 114 and the application server 112 may be implemented as separate servers or as a single server. In some embodiments, the AIDC server 114 and the application server 112 may be implemented as rack servers, blade servers, virtual servers within a cloud computing environment, and the like, but not limited thereto.

In some embodiments, the computing device 106 may be configured to scan or obtain the AIDC means 116 using the input devices thereof. For example, the computing device 106 may include a camera that scans and recognizes QR codes, barcodes, encoded images and/or videos, and the like. Such AIDC means 116 may be displayed on websites, presentations, handouts, advertisements, banners, and the like. The computing device 106 may use a microphone to scan and recognize audio encoded with the data. Such AIDC means 116 may be used in audio-visual advertisements, conferences, music, and the like. Additionally, the computing device 106 may be equipped with other types of sensors and input devices to recognize various AIDC means 116, such as RFID readers for scanning RFID tags, magnetic stripe readers for reading magnetic tapes, optical scanners for recognizing encoded patterns in printed materials, and the like, but not limited thereto. These diverse input devices enable the computing device 106 to interact with a wide range of AIDC means, facilitating seamless data extraction and processing across different contexts and applications.

In some embodiments, the scanned AIDC means 116 may be processed by the system 102. The system 102 may be configured to extract the data encoded in the AIDC means 116. Based on the context, the system 102 may be configured to utilize the extracted data to execute/invoke URLs/URIs associated with software packages/application 306, for example. In some embodiments, the context may correspond to specification of the computing device 106 (such as type, configurations/settings, equipment manufacturer, operating system, version, state, connectivity with wireless communication means, and the like), a number of occasions the AIDC means 116 has been previously interpreted (i.e., scanned, and decoded), whether the software package 306 associated with the data is installed in the computing device 106, and the like. The system 102 may be configured to process the extracted data, and dynamically interpret the extracted data based on the context.

In some embodiments, the extracted data may include content/application data 308 associated with additional features, or installation packages associated with the software package 306. In such embodiments, the system 102 may be configured to install the software package 306 in the computing device 106, or load the content/application data 308 into the software package 306. In other embodiments, the extracted content/application data 308 may correspond to URLs/URIs, from which the data may be retrieved. The URLs/URIs may be associated with the application server 114, a database 110, or a platform/application store (not shown) having the data associated with the software package 306. In some embodiments, the system 102 may be configured to transmit requests to the URLs/URIs extracted from the AIDC means 116, through the network 104.

The network 104 may be any wired or wireless communication network. Examples of wired communication networks may include electrical wires, cables, optical fiber cables, and the like, but are not limited thereto. Examples of wireless communication networks include communications network capable of transferring data using means including, but not limited to, radio communication, satellite communication, a Bluetooth, a Zigbee, a Near-Field Communication (NFC), a wireless fidelity (Wi-Fi) network, a light fidelity (Li-Fi) network, the Internet, a carrier network including a circuit-switched network, a packet-switched network, cellular telecommunication networks, combinations thereof, and the like.

While FIG. 1 illustrates some of the units/components of the architecture 100, it may be appreciated by those skilled in the art that other components/units may be suitably adapted and included in the architecture 100 for the operation of the system 102. Further, the present disclosure describes a few arrangements of components/units of the architecture 100 in FIG. 1, however, it may be appreciated by those skilled in the art that embodiments of the present disclosure may be suitably adapted to have different arrangements of the components/units for the operation of the system 102. While embodiments of the present disclosure have been described in the context of the computing device 106 scanning the AIDC means 116 generated by the AIDC server 114, it may be appreciated by those skilled in the art that the AIDC means 116 may be generated by another computing device/user equipment used by a different user. For example, different users 108 of a software package/application 306 (such as an instant messaging application) may share contact information with each other using their corresponding AIDC means 116. In such examples, the AIDC means 116 may be generated within their corresponding computing devices 106. On scanning the other user's AIDC means 116, a ‘state’ of the software package/application 306 of the computing device 106 operated by the user 108 may be updated, such as a ‘connection status’ of a ‘friend's list,’ for example. In another example, a first user may provide the AIDC means 116 to a second user as a referral to download the software package 306. In such embodiments, the architecture 100 may include any number/instantiations of system 102.

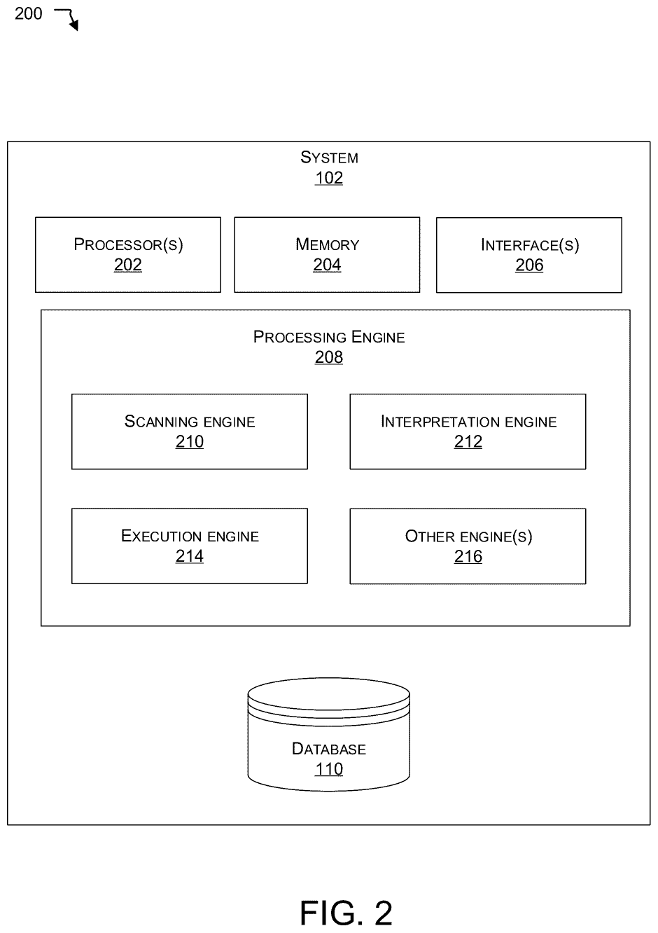

Various components and operations of the system 102 are described in detail in reference to FIG. 2. Referring to block diagram 200 in FIG. 2, the system 102 may include one or more processor(s) 202. The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 may be configured to fetch and execute computer-readable instructions stored in a memory 204. The memory 204 may store the computer-readable instructions or routines, which may be fetched and executed to create or share the data units to other elements of the system 102. The memory 204 may include any non-transitory storage device including, for example, volatile memory such as Random Access Memory (RAM), or non-volatile memory such as an Erasable Programmable Read-Only Memory (EPROM), flash memory, and the like.

In an embodiment, the system 102 may also include an interface(s) 206. The interface(s) 206 may include a variety of interfaces, for example, interfaces for data input and output (I/O) devices, referred to as I/O devices, storage devices, and the like. The interface(s) 206 may facilitate communication between the system 102 and the database 110, and the computing devices 106 using peripherals allowing wireless communication using the network 104. The interface(s) 206 may also provide a communication pathway for one or more components within the system 102. Examples of such components include, but are not limited to, processing engine(s) 208 and the database 110.

While FIG. 1 shows embodiments where the database 110 is implemented external to the system 102, in other embodiments, such as those shown in FIG. 2, the database 110 may be implemented within the system 102. The database 110 may also include data that is either stored or generated as a result of functionalities implemented by any of the components of the processing engine(s) 208.

In an embodiment, the processing engine(s) 208 may be implemented as a combination of hardware and software (for example, programmable instructions) to implement one or more functionalities of the processing engine(s) 208. In examples described herein, such combinations of hardware and software may be implemented in several different ways. For example, the software for the processing engine(s) 208 may be processor-executable instructions stored on a non-transitory machine-readable storage medium and the hardware for the processing engine(s) 208 may include a processing resource (for example, one or more processors), to execute such instructions. In other embodiments, the processing engine(s) 208 may be implemented by electronic circuitry.

In some embodiments, the processing engine(s) 208 may include a scanning engine 210, an interpretation engine 212, an execution engine 214, and other engine(s) 216. The other engine(s) 216 may implement functionalities that supplement applications/functions performed by the system 102.

In some embodiments, the scanning engine 210 may be configured to scan and extract data encoded within the AIDC means 116. As stated, the AIDC means 116 may be generated by the AIDC server 114, in any one of a plurality of formats. The AIDC means 116 may be encoded with content/application data 308, installation packages of the software package 306, or both; or URLs/URIs that redirect the computing device 106 to the content/application data 308 or the installation packages. The scanning engine 210 may use a corresponding input device of the computing device 106 to scan the AIDC means 116. When the AIDC means 116 includes the content/application data 308 or the installation packages, the execution engine 214 may be configured to install the installation packages and/or load the content/application data 308 into the software package 306 installed in the computing device 106. In other embodiments, the interpretation engine 212 may be configured to interpret the URLs/URIs, and other data/information extracted from the AIDC means 116, based on which the execution engine 214 may perform a corresponding action. In other embodiments, the data may be extracted from input provided by the user 108. In such embodiments, the user 108 may input the URLs/URIs through input devices such as touchscreens or keyboards into the computing device 106.

In some embodiments, the interpretation engine 212 may be configured to dynamically interpret the extracted data based on the context. The context may correspond to the number of times/occasions the AIDC means 116 has been scanned (or the URL/URI in the extracted data has been accessed), whether the software package 306 is installed within the computing device 106, and the specification of the computing device 106. For example, on a first time or initial occasion of scanning the AIDC means 116, the extracted data may include a URL/URI that directs the computing device 106 to an app store to download the software package 306 (or installation packages thereof). Once the software package 306 is installed, scanning the same AIDC means 116 a second time or a subsequent occasion may result in the extracted data being interpreted to download additional content or data specific to the software package 306. In some embodiments, the dynamic interpretation may be indicated by the execution engine 214 in the corresponding requests transmitted to the application server 114, which may respond based on the indication (such as by providing installation packages or the content/application data 308). In some embodiments, either the computing device 106, or the application server 114 may maintain the count of the number of times the URLs/URIs in the extracted data are accessed. This dynamic interpretation ensures that the same AIDC means 116 may lead to the performance of different actions based on the context of its usage.

In another example, consider a scenario where the extracted data includes a URL/URI associated with a map application. If the map application is not installed on the computing device 106, the interpretation engine 212 may interpret the extracted data to redirect the user to an app store to download the map application. In some embodiments, the extracted data may include a URI. On accessing the URI, the interpretation engine 212 may determine if the software package 306 is installed in the computing device 106 (such as by transmitting a request to the URI). In such embodiments, the software package 306 may be configured to respond or intercept the request, if the software package 306 is installed. However, if the map application is already installed, the interpretation engine 212 may interpret the extracted data to load specific map data (or generally any content/application data 308), such as the map of a new location, directly into the installed map application. The content/application data 308 may be retrieved from the application server 114 or from the database 110, by transmitting a request to the URL/URI in the AIDC means 116 and receiving a response from the application server 112. In other examples, where the content/application data 308 is included in the extracted data, the content/application data 308 may be directly loaded to the software package 306. This context-aware interpretation simplifies the user experience by dynamically adjusting the actions based on whether the software package 306 is installed or not.

In some embodiments, the execution engine 214 may be configured to execute one or more operations, such as transmitting API signals, installing software packages 306, executing predefined computer programs/processor-executable instructions, loading content/application data 308 into the software packages 306, and the like. In some embodiments, the execution engine 214 may be configured to execute the operations based on the interpretation of the extracted data by the interpretation engine 212, as described above. The execution engine 214 may be configured to include indications of the context (such as specification of the computing device 106) as parameters in the requests, and receive the appropriate installation packages and/or the content/application data 308 from the application server 114. Further, the execution engine 216 may be configured to install the installation packages and load the content/application data 308 therein.

Referring to FIGS. 3A and 3B, the system 102 (through the interpretation engine 212) may be configured to execute different sets of operations (through the execution engine 214) using the extracted data based on the context.

In some embodiments, the AIDC server 114 may be configured to generate the AIDC means 116 using data 302. In some embodiments, the data 302 may correspond to installation packages associated with the software application/software packages 306, such as installation packages of a map application. In other embodiments, the data 302 may be specific content/application data 308 or information associated with the software application 306, like map data associated with a specific city or a location. In further embodiments, the data 302 may be URLs, URIs, or other unique identifiers, which may allow for redirection to other links/resources from which the installation packages and/or the content/application data 308 may be retrieved. The AIDC server 114 may be configured to encode the data 302 into the AIDC means 116, as encoded data 304. In the example shown in FIGS. 3A and 3B, the AIDC means 116 may be a QR code. However, it is appreciated by those skilled in the art that the AIDC means 116 may be any one or a combination of encoded media (images, audio, videos, and the like), barcodes, magnetic strips, RFIDs, and the like.

In some embodiments, while a URL/URI may be unique, multiple URLs/URIs (corresponding to different AIDC means 116) may point to the same webpage or other resource, such as URLs/URIs that redirect to a parent URL/URI or URLs/URIs having parameters. For example, multiple unique URLs/URIs may be used to express the QR code for a state, or provide an indication of origin of the URL/URI. This can include different paths (e.g., sub-paths), different domains, different sources or marketing channels, and/or different parameters encoded within the URLs/URIs. By employing multiple QR codes or URLs/URIs, multiple sources can be tracked. For instance, the state (such as additional app content) may be promoted across various channels, including websites, ad campaigns, podcasts, mail campaigns, email campaigns, and talk slides, each channel having a corresponding unique URL associated therewith. Although the URL/URIs in the QR code that leads to the installation packages of the software package 306 is not shared by the application store, post-download usage of the QR code to change the state allows the unique QR code corresponding to the unique source to be tracked. This enables the QR code to function in the pre-download state to facilitate easy downloading of the software packages 306 and in the post-download state to access data and/or track the source.

In some embodiments, the computing device 106 may be used to scan the AIDC means 116. Different input devices may be used to scan different types of AIDC means 116. In the foregoing example, the QR code may be scanned using a camera of the computing device 106. In some embodiments, the computing device 106, using the system 102, may extract the encoded data 304 from the AIDC means 116. For example, the camera may be used to capture an image of the QR code, which may be cropped and processed by the system 102, such as using the scanning engine 210.

In some embodiments, the system 102 may be configured to extract the encoded data 304, and dynamically interpret the extracted data. In an example, when the encoded data 304 may include a URL/URI associated with the software application/package 306. The system 102 may transmit a request to the URL/URI. If the QR code (or generally the AIDC means 116) is being scanned and/or interpreted for a first time or an initial occasion by the computing device 106, the system 102 may be redirected to a platform/application store from which the installation packages of the software package 306 may be downloaded/retrieved, as shown in FIG. 3A. In such cases, it is assumed that the software package 306 is not installed in the computing device 106 at the time of scanning the QR code. In some examples, the installation packages may be retrieved from the application server 112, or through a platform of application store. If/when the software package 306 is installed, and the QR code (or generally the AIDC means 116) is scanned/interpreted for a second time or subsequent occasions after the software package 306 has been installed, the system 102 may be configured to load the extracted data into the installed software package 306, as shown in FIG. 3B. Alternatively, if the extracted data corresponds to a URL/URI, the system 102 may be configured to retrieve the application data 308 by transmitting requests to the URL/URI, and receiving a response therefor. The data may then be loaded and viewed through the installed software package 306.

In such embodiments, either the computing device 106, the system 102, or the application server 114 may be configured to maintain a count or the number of times the AIDC means 116 is being interpreted/scanned/accessed. For example, the computing device 106 may be configured to temporarily update its state to indicate that the QR code has been scanned at least once. In other examples, the system 102 may transmit a request and retrieve the installation packages of the software package 306 from the application server 112, on the first time/initial occasion. In such examples, the application server 112 may maintain a record of the number of times the computing device 106 (uniquely identified using an Internet Protocol (IP) address, or any other unique identifier) accessed the URLs/URIs in the AIDC means 116. Alternatively, upon installing the software package 306, an installation signal may be transmitted to the application server 112. The application server 112 may then update databases thereof, which maintains the list of active users, on receiving the installation signal. The second time or the subsequent occasions in which the system 102 transmits signals to the URLs/URIs in the QR code to the application server 112, the application server 112 may be configured to transmit the content/application data 308, instead of the installation packages.

In some embodiments, the extracted data may include a URI associated with the software package 306 and/or the computing device 106. In such embodiments, the system 102 may be configured to transmit a request to the URI, which may respond with the context. The context may indicate at least one of, whether the software package 306 has been installed in the computing device 106, a number of occasions the AIDC means 116 has been interpreted, and specifications of the computing device 106. For example, the specification may indicate the operating system used by the computing device 106. Based on the operating system, and on accessing the URLs/URIs also encoded in the AIDC means 116, the system 102 may be redirected to an appropriate platform/application store to download the corresponding versions of the installation packages of the software package 306, if the software package 306 is already not installed in the computing device 106. In some embodiments, the context may be transmitted to the application server 112, such as through browser's user agent parameter, which may accordingly either supply the corresponding installation packages and/or the application data 308, or redirect the system 102 to the appropriate platform/application store. Such embodiments may allow multiple ones of the user 108 to find the intended software packages 306 and/or the application data 308 despite differences in spelling, naming, search, or other variations in two or more platforms/application stores from which the software package/application 306 can be downloaded.

In further embodiments, the context may correspond to the application used for scanning AIDC means 116. In some embodiments, for the first occasion, the AIDC means 116 may be scanned using a dedicated AIDC scanner. Such applications may be dedicated applications/engines/programs built for scanning and extracting data from AIDC means 116, such as QR code scanner application. Further, if the data includes a URL/URI, the dedicated AIDC scanning application may transmit a request (as an API signal/request) to retrieve installation packages from the extracted URL/URI, if the software package 306 was not installed in the computing device 106 (which may be identified using techniques described above.) Once the software package 306 is retrieved and installed, the user 108 may use embedded AIDC scanners within the software package 306 to scan and extract data from the AIDC means 116 in the second/subsequent occasion. The embedded AIDC scanners may be applications/engines/programs or features provided within the software package/application 306. In such embodiments, the embedded AIDC scanner may be configured to scan and extract the URL/URI, and transmit a request to the extracted URL/URI for downloading and loading the desired content/application data 308. In such embodiments, the origin of the request sent to the URL/URI (i.e., whether the request is transmitted through the dedicated AIDC scanner or the embedded AIDC scanner, or other applications such as the browser) may be indicated using keys, user agent parameters, URL parameters, and the like, in the request, which may be unique to each source/origin. The application server 112 may be configured to respond to the request with the appropriate data based on the parameters included in the request. Hence, the system 102 may interpret the same AIDC means 116 dynamically/differently, based on the context.

In total, the system 102 requires the user 108 to at most interact 2-4 times to either load the application data 308 or both install the software package 306 and load the application data 308, which can be completed in a matter of seconds. In contrast, the existing solutions involve significantly more typing, thereby increasing the potential for user error. Moreover, the time required extends from a few seconds to several tens of seconds for existing solutions, where URLs/URIs have to be typed manually. Although this difference may appear minor, it can result in a substantial reduction in user conversion rates.

Additionally, unlike existing solutions that scan and decode information/data from AIDC means 116, the system 102 may be configured to dynamically interpret the AIDC means 116 based on the context (i.e., the number of occasions the AIDC means 116 has been interpreted, the specifications of the computing device 106, and/or the whether the software package 306 has been installed in the computing device 106). Dynamic interpretation also enables the same AIDC means 116 to be used for causing the computing device 106 to perform different actions, such as downloading and installing the software package/application 306 on the AIDC means 116 may scanned and interpreted for the first occasion, and downloading and loading the content/application data 308 into the software package/application 306 on the same AIDC means 116 being scanned and interpreted for the second or subsequent occasion.

Additionally, the operation of the system 102 as described in the present disclosure may be differentiated from deferred deep linking techniques. For instance, the system 102 dynamically and/or differently interprets the same AIDC means 116 (and the same encoded data or URLs/URIs therein) on the first and subsequent occasions of scanning to either download and install the software package 306 in the computing device 106, or load content/application data 308 into the software package 306 based on the context (such as number of occasions the AIDC means 116 has been scanned, among others). Meanwhile, in deferred deep linking techniques, which involve either retrieving, modifying, and/or generating new URLs/URIs to download and install the software packages 306, when the required software package 306 to load the content/application data 308 is unavailable. However, creation of new URLs/URIs may potentially lead to loss of context, thereby making it difficult to track source/origin of the requests. Additionally, many operating systems/user equipment manufacturers do not inherently support compatible deferred deep linking protocols, which adds complexity for developers who must implement custom solutions or integrate third-party solutions for creating new URLs/URIs to support deferred deep linking, which further creates privacy issues. By using a two-step process where the system 102 interprets the AIDC means 116 dynamically/differently on first and subsequent scans. As described, the system 102 may be configured to determine whether the AIDC means 116 is being scanned for the first occasion or the subsequent occasion (by maintaining a count of the same, or determining presence or absence of the software package 306), and interpret the same URL/URI differently based on the context. In other embodiments, the AIDC means 116 may also be encoded with multiple URLs/URIs (each for downloading installations packages of the software application 306, and/or the content/application data 308) that may be dynamically selected and invoked based on the context, thereby eliminating the need for creating/retrieving new URLs/URIs to download the installation packages and providing a solution that is compatible with multiple platforms and/or operating systems of the computing device 106.

### Example Scenario 1

Consider a software application/app that provides supplemental information for many books. Multiple authors include their supplemental content in this app. The authors may wish for their readers (or perhaps potential readers, as this may promote more book sales) to access this content through the app, thereby requiring the readers to download the app and then download their content specifically. At the end of a lecture, the authors may include the QR code for their content on a slide. With only 3-4 clicks or interaction, in a matter of seconds, the (potential) readers/audience may be able to download and install the app, and load the author's content. The author and her brand are retained better with the audience and the audience gets the desired additional resources (e.g., takeaway notes from the class). Without this, the author must guide people through two addresses (such as QR codes), one for the app and one for the content, or, alternatively, provide the QR code for the app along with instructions on how to now open the app and find her content. The system 102, hence reduces complexity and improves engagement.

### Example Scenario 2

Many authors of business and self-help books may have additional exercises or activities done outside the house, when the physical book may not be available. Likewise, these authors want to stay top of mind with their readers to promote word-of-mouth marketing. They are interested in having readers of their print books have some additional content in the app, such as in the app described in Example scenario 1. On the first page of their book the author may instruct the reader, “download our content on this app so you have the instructions for the exercise at your fingertips.” (In more complicated apps it may not simply be text instructions, but interactive code added to the app which now guides the reader through the app, effectively changing how the app operates.) Instead of asking the reader to type by hand a URL written on the page, or search for the app and then also the author's content, the author includes the QR for her content on the first page. The reader simply takes his phone and snaps the QR code once to find and install the app and then a second time to install the author's content and they are done.

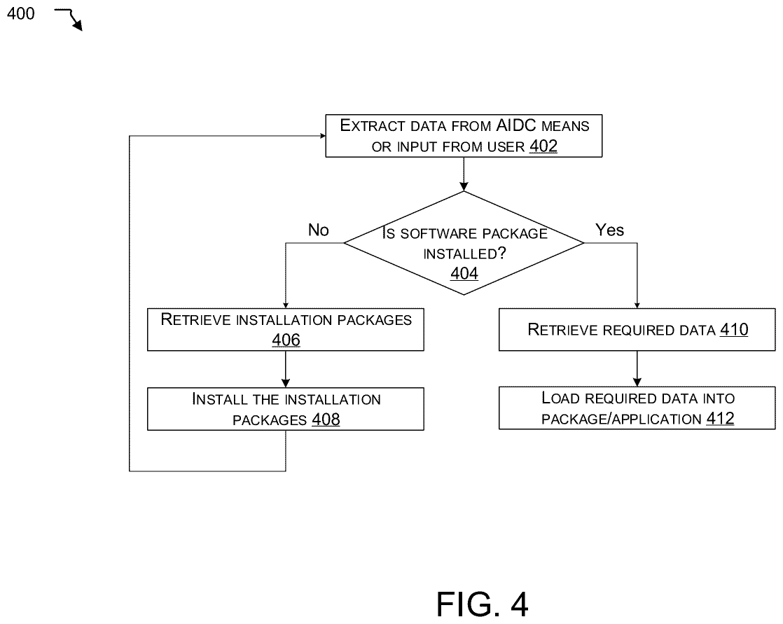

Referring to FIG. 4, a flowchart of an example method 400 for dynamic interpretation of AIDC means (such as AIDC means 116) is illustrated. The method 400 may be implemented by the system 102. When the AIDC means 116 is scanned for the first time/initial occasion, the method 400 may execute steps 402 to 408.

At step 402, the method 400 begins with extracting, by a processor (such as processor 202 of FIG. 2), data from an AIDC means 116 or an input provided by a user through a computing device (such as user 108 and computing device 106 of FIG. 1, respectively). In some embodiments, the AIDC means 116 may include, but is not limited to, QR codes, barcodes, magnetic tapes, RFIDs, or encoded media, and a corresponding input device may be used to scan and extract the encoded data (e.g., 304) therein. For example, the user 108 may scan or capture an image of the AIDC means 116 indicative of a QR code using a camera of the computing device 106, which may, using the system 102, extract the encoded data 304 therein. The encoded data 304 may be a URL/URI pointing to a content/application data 308 and/or installation packages of a software package/application (such as software package 306 of FIGS. 3A and 3B), or the encoded data 304 may have the content/application data 308 or the installation packages encoded in the AIDC means 116. In other embodiments, the user 108 may provide (such as through typing) URLs/URIs as input.

In some embodiments, the method 400 includes dynamically interpreting, by the processor 202, the extracted data based on a context. The context may include specifications of the computing device 106, whether applications associated with the extracted data are pre-installed in the computing device 106, and the like. For example, at step 404, the method 400 includes determining if the software package/application 306 is installed in the computing device 106. In some embodiments, the context may be determined by maintaining a count of the number of times the AIDC means 116 has been scanned, which may be maintained either at the computing device 106, or at the application server 112. In other embodiments, the context may be determined by transmitting a request/signal to a URI within the computing device 106, which may indicate the presence or absence of the software package/application 306 within the computing device 106.

The method 400 includes executing, by the processor 202, an action based on the dynamic interpretation of the extracted data. For example, if no at step 404, the method 400 proceeds to step 406, where the method 400 includes retrieving, by the processor 202, installation packages associated with the software package/application 306, from the application server 114. The application server 114 may be accessed directly, through a platform/application store. In some embodiments, the installation packages may be retrieved by transmitting a request (such as an API request) to the URL/URI in the extracted data. In some embodiments, the request may be transmitted through the browser, which may indicate specifications of the computing device 106, such as type of device, equipment manufacturer, the operating system used, versions, and the like. The application server 114 may be configured to respond to the request by transmitting the appropriate installation packages to the computing device 106, based on the specifications of the computing device 106. The method 400 may then proceed to step 408, where the installation packages may be installed. Further, in embodiments where the installation packages are included in the AIDC means 116, the method 400 proceeds to step 408 directly from step 404.

In another example, if yes at step 404, the method 400 proceeds to step 410. In some embodiments, if the software package 306 is installed at the time of scanning and extracting the URL/URI from the AIDC means 116, the software package 306 may be configured to intercept the URL/URI, and either cause the application data 308 to be retrieved and loaded to the software package 306, remove the application data 308 from the software package 306, or change state of the software package 306.

In other embodiments, after installing the software package/application 306 the method 400 includes returning to step 402. In such embodiments, the user 108 may scan the AIDC means 116 for the second time. For each subsequent scanning of the AIDC means 116, the method 400 may execute steps 402, 404, 410, and 412. If the software package/application 306 is determined to be installed in the computing device 106 at step 404, the method 404 executes steps 410 and 412.

At step 410, the method 400 includes retrieving, by the processor 202, application data 308 associated with the software package/application 306, from the application server 114. In some embodiments, the application data 308 may be retrieved by transmitting a request (such as an API request) to the URL/URI in the extracted data. In some embodiments, the request may be transmitted through the browser, which may indicate specifications of the computing device 106, such as type of device, equipment manufacturer, the operating system used, versions, and the like. The application server 114 may be configured to respond to the request by transmitting the appropriate version of the application data 308 to the computing device 106, based on the specifications of the computing device 106. The method 400 may then proceed to step 412, where the application data 308 may be loaded into the software package/application 306. Further, in embodiments where the application data 308 is included in the AIDC means 116, the method 400 proceeds to step 412 directly from step 404.

In summary, the method 400 provides a streamlined process for dynamically interpreting and executing actions dynamically based on data extracted from AIDC means 116, thereby simplifying the user experience and improving engagement.

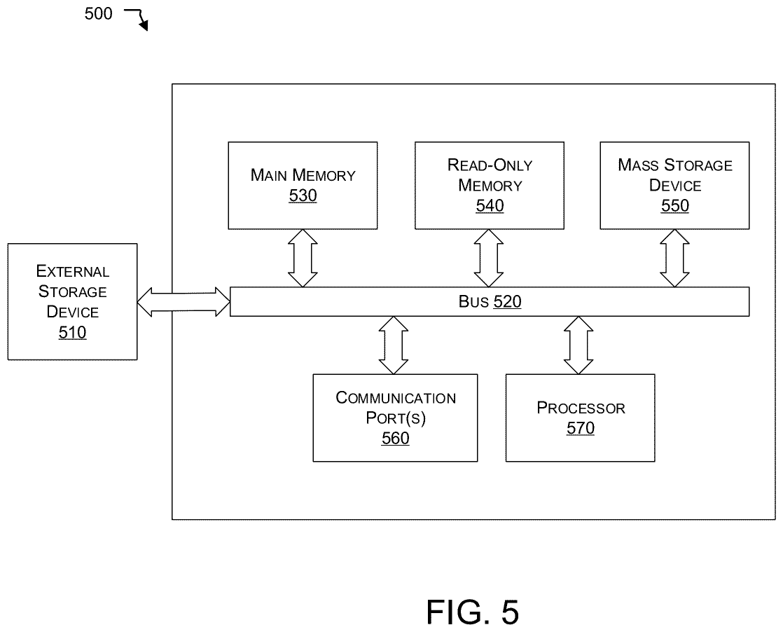

The system 102 and the method 400 may be implemented on a computer system. Referring to FIG. 5, the block diagram represents a computer system 500 that includes an external storage device 510, a bus 520, a main memory 530, a read only memory 540, a mass storage device 550, a communication port 560, and a processor 570. A person skilled in the art will appreciate that the computer system 500 may include more than one processor 570 and communication ports 560. The processor 570 may include various modules associated with embodiments of the present disclosure. The communication port 560 can be any of a Recommended Standard 232 port for use with a modem-based dialup connection, a 10/100 Ethernet port, a Gigabit or 10 Gigabit port using copper or fiber, a serial port, a parallel port, or other existing or future ports. The communication port 560 may be chosen depending on a network, such as a Local Area Network (LAN), a Wide Area Network (WAN), or any network to which computer system 500 connects.

In an embodiment, the memory 530 can be a RAM, or any other dynamic storage device commonly known in the art. The Read-Only Memory (ROM) 540 may be any static storage device(s) e.g., but not limited to, a Programmable Read-Only Memory (PROM) chip for storing static information. The mass storage 560 may be any current or future mass storage solution, which may be used to store information and/or instructions. Exemplary mass storage solutions may include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus 520 communicatively couples the processor(s) 570 with the other memory, storage, and communication blocks. The bus 520 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor 570 to the computer system 500.

In another embodiment, operator and administrative interfaces, e.g., a display, keyboard, and a cursor control device, may also be coupled to the bus 520 to support direct operator interaction with computer system 500. Other operator and administrative interfaces may be provided through network connections connected through communication port 560. In some embodiments, the external storage device 510 can be any kind of external hard-drives, floppy drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system 500 limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

What is claimed is:

1. A method for dynamic interpretation of automatic identification and data collection (AIDC) means, comprising:
extracting, by a processor, data from an AIDC means or an input provided by a user through a computing device;
dynamically interpreting, by the processor, the extracted data based on a context; and
executing, by the processor, an action based on the dynamic interpretation of the extracted data.

2. The method of claim 1, wherein the data extracted from the AIDC means or input provided by the user comprises at least one of: a Uniform Resource Locator (URL) associated with an application server of a software package, application data associated with the software package, or installation packages associated with the software package.

3. The method of claim 1, wherein for dynamically interpreting the extracted data, the method comprises:
for the extracted data being interpreted for an initial occasion, retrieving, by the processor, a software package associated with the extracted data from an application server; and
for the extracted data being interpreted for a subsequent occasion, retrieving, by the processor, application data associated with the installed software package, from the application server.

4. The method of claim 3, wherein for executing an action based on dynamic interpretation of the extracted data, the method comprises either:
installing, by the processor, the software package retrieved from the application server; or
loading, by the processor, the application data from the application server into the software package.

5. The method of claim 1, wherein the context comprises an indication of at least one of: whether the software package has been installed in the computing device, a number of occasions the AIDC means has been interpreted, or specifications of the computing device.

6. The method of claim 1, wherein the AIDC means is any one or a combination of quick response (QR) codes, barcodes, magnetic tapes, radio-frequency identifiers (RFIDs), or encoded media.

7. The method of claim 1, wherein the AIDC means or a Uniform Resource Locator (URL) encoded within the AIDC means comprise an indication of origin.

8. A system for dynamic interpretation of automatic identification and data collection (AIDC) means, comprising:
a processor; and
a memory operatively coupled to the processor, wherein the memory comprises one or more processor-executable instructions, which, when executed, cause the processor to:
extract data from an AIDC means or an input provided by a user through a computing device;
dynamically interpret the extracted data based on a context; and
execute an action based on the dynamic interpretation of the extracted data.

9. The system of claim 8, wherein the data extracted from the AIDC means or input provided by the user comprises at least one of: a Uniform Resource Locator (URL) associated with an application server of a software package, application data associated with the software package, or installation packages associated with the software package.

10. The system of claim 8, wherein to dynamically interpret the extracted data, the processor is configured to:
for the extracted data being interpreted for an initial occasion, retrieve a software package associated with the extracted data from an application server; and
for the extracted data being interpreted for a subsequent occasion, retrieve application data associated with the installed software package from the application server.

11. The system of claim 10, wherein to execute the action based on dynamic interpretation of the extracted data, the processor is further configured to either:
install the software package retrieved from the application server; or
load the application data from the application server into the software package.

12. The system of claim 8, wherein the context comprises an indication of at least one of: whether the software package has been installed in the computing device, a number of occasions the AIDC means has been interpreted, or specifications of the computing device.

13. The system of claim 8, wherein the AIDC means is any one or a combination of quick response (QR) codes, barcodes, magnetic tapes, radio-frequency identifiers (RFIDs), or encoded media.

14. The system of claim 8, wherein the AIDC means or a Uniform Resource Locator (URL) encoded within the AIDC means comprise an indication of origin.

15. A non-transitory computer-readable medium comprising one or more instructions to:
extract data from an AIDC means or an input provided by a user through a computing device;
dynamically interpret the extracted data based on a context; and
execute an action based on the dynamic interpretation of the extracted data.

16. The non-transitory computer-readable medium of claim 15, wherein the data extracted from the AIDC means or input provided by the user comprises at least one of: a Uniform Resource Locator (URL) associated with an application server of a software package, application data associated with the software package, or installation packages associated with the software package.

17. The non-transitory computer-readable medium of claim 15, wherein to dynamically interpret the extracted data, the one or more instructions comprise:
for the extracted data being interpreted for an initial occasion, retrieve a software package associated with the extracted data from an application server; and
for the extracted data being interpreted for a subsequent occasion, retrieve application data associated with the installed software package from the application server.

18. The non-transitory computer-readable medium of claim 17, wherein to execute the action based on dynamic interpretation of the extracted data, the one or more instructions comprise either:
install the software package retrieved from the application server; or
load the application data from the application server into the software package.

19. The non-transitory computer-readable medium of claim 15, wherein the context comprises an indication of at least one of: whether the software package has been installed in the computing device, a number of occasions the AIDC means has been interpreted, or specifications of the computing device.

20. The non-transitory computer-readable medium of claim 15, wherein the AIDC means or a Uniform Resource Locator (URL) encoded within the AIDC means comprise an indication of origin.
